(19) United States
(12) Patent Application Publication
(10) Pub. No.: US 2005/0187367 A1
(43) Pub. Date: Aug. 25, 2005

(54) Biaxially oriented polypropylene film

(75) Inventors: Hideaki Hori, Sodegaura-shi (JP); Takeshi Ebara, Chiba-shi (JP); Yoichi Obata, Sodegaura-shi (JP)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: Sumitomo Chemical Company, Limited

(21) Appl. No.: 11/054,511

(22) Filed: Feb. 9, 2005

(30) Foreign Application Priority Data
Feb. 19, 2004 (JP) 2004-042583

(51) Int. Cl. C08F 10/00

(52) U.S. Cl. 526/348.1; 428/910; 264/435; 264/901

(57) ABSTRACT

Disclosed is a biaxially oriented film made of a thermoplastic material containing a polypropylene satisfying the following requirements (1), (2) and (3): (1) the polypropylene has a melting point from 150° C. to 165° C., (2) the 20° C. xylene-soluble fraction content in the polypropylene is from 0.1% by weight to 2% by weight, (3) the polypropylene has a melt flow rate from 0.1 g/10 min. to 10 g/10 min., wherein the film satisfies the following formula (I):
Y≦−850×S+7000 (I) wherein S represents the thermal shrinkage of the film in the MD at 130° C. and Y represents the Young's modulus of the film in the TD, and wherein the thermal shrinkage of the film in the MD at 120° C. is 3% or less.

### BACKGROUND OF THE INVENTION

1. Field of the Invention

The present invention relates to biaxially oriented polypropylene films, and particularly to biaxially oriented polypropylene films which are excellent in rigidity and also in dimension stability and anti-blocking property at high temperatures.

2. Description of the Background Art

Biaxially oriented polypropylene films are used for various applications because they are superior in economy, transparency, moisture barrier property, chemical resistance, and the like.

For example, Japanese Patent Application Unexamined Publication No. 59-149909 discloses a propylene copolymer, wherein the 1-butene content (Bc) is 0.1-2.5 mole % and the isotactic value (Iso) is within the range defined by the following formulas (1) and (2):
when 0.1≦Bc≦0.3 mole %, Iso≧−5Bc+96.3 (1)
when 0.3<Bc≦2.5 mole %, Iso≧0.60Bc+95.0 (2).
The copolymer is reported to be superior in stretchability, impact resistance, resistance to thermal shrinkinge, transparency and rigidity. The document also discloses biaxially oriented films made from the copolymer.

Japanese Patent Application Unexamined Publication No. 2002-128825, which corresponds to U.S. 2002/107351 A1, discloses a propylene-based polymer having a melt flow rate of 0.1-20 g/10 min. and a melting point (Tm) measured by differential scanning calorimetry (DSC) of 147-159° C., wherein the half-width HW (° C.) of the fusion peak in its fusion curve (DSC curve) and the melting point Tm (° C.) satisfy the relationship HW≦(188−Tm)/5. The document also discloses biaxially oriented films produced using the polyproylene-based polymer.

The conventional biaxially oriented films mentioned above are unsatisfactory in rigidity and also in dimension stability and anti-blocking property at high temperature. Biaxially oriented films may be exposed to high temperatures, particularly, during a drying step in aqueous ink printing or during a step of drying a release agent, which step is conducted during the production of a release sheet including a step of coating the release agent. Such films are, therefore, requested to have improved dimension stability at high temperatures.

### SUMMARY OF THE INVENTION

The object of the present invention is to provide biaxially oriented polypropylene films which are excellent in rigidity and also in dimension stability and anti-blocking property at high temperatures.

In one aspect of the present invention, there is provided a biaxially oriented film made of a thermoplastic material containing a polypropylene satisfying the following requirements (1), (2) and (3):
(1) the polypropylene has a melting point from 150° C. to 165° C.,
(2) the 20° Cxylene-soluble fraction content in the polypropylene is from 0.1% by weight to 2% by weight,
(3) the polypropylene has a melt flow rate from 0.1 g/10 min. to 10 g/10 min.,
   wherein the film satisfies the following formula (I):
   Y≦−850×S+7000 (I)
   wherein S represents the thermal shrinkage of the film in the longitudinal direction (MD) at 130° C. and Y represents the Young's modulus of the film in the transverse direction (TD), and wherein the thermal shrinkage of the film in the MD at 120° C. is 3% or less.

### DESCRIPTION OF THE PREFERRED EMBODIMENTS

The “thermoplastic material” which constitutes the biaxially oriented film of the present invention is a material which contains a polypropylene satisfying the above-mentioned requirements (1) (2) and (3) usually in an amount of 80% by weigh or more, preferably in an amount of 90% by weight or more. The thermoplastic material may further contain desired amounts of additional ingredients (e.g., various types of additives). The thermoplastic material is required only to be thermoplastic as a whole. In other words, not all the ingredients of the thermoplastic material must be thermoplastic. The temperature at which the thermoplastic material can be plasticized is not limited and may, in general, be temperatures lower than the decomposition temperatures of the ingredients contained in the material.

In the present invention, polypropylene refers to a polymer including more than 50% by weight of structural units derived from propylene monomers. Specific examples thereof include propylene homopolymers, propylene-ethylene copolymers and copolymers of propylene and α-olefin having four or more carbon atoms. In the following description, the term “α-olefin having four or more carbon atoms” is referred to simply as “α-olefin” unless otherwise stated.

The polypropylene used in the present invention is selected preferably from propylene-ethylene copolymers and copolymers of propylene and α-olefin, and more preferably is a propylene-1-butene copolymer.

The α-olefin in the copolymer of propylene and α-olefin is preferably any of a-olefins having 4-20 carbon atoms, specifically, 1-butene, 2-methyl-1-propene, 1-pentene, 2-methyl-1-butene, 3-methyl-1-butene, 1-hexene, 2-ethyl-1-butene, 2,3-dimethyl-1-butene, 2-methyl-1-pentene, 3-methyl-1-pentene, 4-methyl-1-pentene, 3,3-dimethyl-1-butene, 1-heptene, 2-methyl-1-hexene, 2,3-dimethyl-1-pentene, 2-ethyl-1-pentene, 2,3,4-trimethyl-1-butene, 2-methyl-3-ethyl-1-butene, 1-octene, 5-methyl-1-pentene, 2-ethyl-1-hexene, 3,3-dimethyl-1-hexene, 2-propyl-1-heptene, 2-methyl-3-ethyl-1-heptene, 2,3,4-trimethyl-1-pentene, 2-propyl-1-pentene, 2,3-diethyl-1-butene, 1-nonene, 1-decene, 1-undecene, 1-dodecene, 1-tridecene, 1-tetradecene, 1-pentadecene, 1-hexadecene, 1-heptadecene, 1-octadecene and 1-nonadecene. Preferred area-olefins having 4-12 carbon atoms, specific examples of which include 1-butene, 2-methyl-1-propene, 1-pentene, 2-methyl-1-butene, 3-methyl-1-butene, 1-hexene, 2-ethyl-1-butene, 2,3-dimethyl-1-butene, 2-methyl-1-pentene, 3-methyl-1-pentene, 4-methyl-1-pentene, 3,3-dimethyl-1-butene, 1-heptene, 2-methyl-1-hexene, 2,3-dimethyl-1-pentene, 2-ethyl-1-pentene, 2,3,4-trimethyl-1-butene, 2-methyl-3-ethyl-1-butene, 1-octene, 5-methyl-1-pentene, 2-ethyl-1-hexene, 3,3-dimethyl-1-hexene, 2-propyl-1-heptene, 2-methyl-3-ethyl-1-heptene, 2,3,4-trimethyl-1-pentene, 2-propyl-1-pentene, 2,3-diethyl-1-butene, 1-nonene, 1-decene, 1-undecene and 1-dodecene.

From the viewpoint of copolymerizability, 1-butene, 1-pentene, 1-hexene and 1-octene are preferable. 1-Butene and 1-hexene are particularly preferable.

The polypropylene has a melting point (Tm) from 150° C. to 165° C. The Tm is preferably not lower than 155° C., and more preferably not lower than 160° C. On the other hand, the Tm is preferably not higher than 165° C., and more preferably not higher than 164° C. If the Tm is lower than 150° C., biaxially oriented films may have an unsatisfactorily low rigidity or may undergo an unsatisfactorily large thermal shrinkage. If Tm is higher than 165° C., a too high stress will generate during a stretching process and, in some cases, it is impossible to obtain oriented films.

The Tm of polypropylene is defined as a temperature (° C.) at which a highest endothermic peak is observed in the fusion curve (DSC curve) of the polypropylene measured by differential scanning calorimetry (DSC).

From the viewpoint of thermal shrinkage of biaxially oriented films, the 20° C. xylene-soluble fraction content, namely the content of the fractions soluble in xylene at 20° C. (abbreviated as CXS), in the polypropylene is from 0.1% by weight to 2% by weight, preferably from 0.1% by weight to 1.5% by weight, and more preferably from 0.1% by weight to 1.0% by weight.

The melt flow rate (abbreviated as MFR) of the polypropylene is from 0.1 g/10 min. to 10 g/10 min. The MFR is preferably not lower than 1 g/10 min. Further, the MFR is preferably not higher than 7 g/10 min., and more preferably not higher than 5 g/10 min. If the MFR is lower than 0.1 g/10 min., the fluidity of the thermoplastic material containing the polypropylene may be unsatisfactorily low, whereas if the MFR is higher than 10 g/10 min., breakage will occur in the material during its stretching process.

When the polypropylene is a propylene-ethylene copolymer, the content of the structural units derived from ethylene (henceforth, referred to as “ethylene content”) in the polypropylene is preferably not less than 0.1% by weight, more preferably not less than 0.3% by weight, and even more preferably not less than 0.5% by weight. On the other hand, the ethylene content is preferably not more than 3% by weight, more preferably not more than 2.5% by weight, and even more preferably not more than 2% by weight.

When the polypropylene is a propylene-α-olefin copolymer, the content of the structural units derived from α-olefin (henceforth, referred to as “α-olefin content”) in the polypropylene is preferably not less than 0.1% by weight, more preferably not less than 0.5% by weight, and even more preferably not less than 1% by weight. On the other hand, the α-olefin content is preferably not more than 6% by weight, more preferably not more than 5% by weight, and even more preferably not more than 4% by weight.

Examples of the method for the production of the polypropylene include a method in which propylene is polymerized alone or propylene is copolymerized with ethylene or α-olefin in the presence of a conventionally known polymerization catalyst.

Examples of the conventionally known catalyst include:
(1) a Ti—Mg catalyst system comprising a solid catalyst component composed mainly of magnesium, titanium and halogen;
(2) a catalyst system comprising a combination of a solid catalyst component composed mainly of magnesium, titanium and halogen, an organoaluminum compound, and, if desired, a third component such as an electron-donating compound; and
(3) a metallocene catalyst.

Preferred is the catalyst system comprising a combination of a solid catalyst component composed mainly of magnesium, titanium and halogen, an organoaluminum compound and an electron-donating compound.

For example, in the case where a polypropylene is produced by polymerization using a catalyst system comprising a combination of a solid catalyst component composed mainly of magnesium, titanium and halogen, an organoaluminum compound and an electron-donating compound, it is possible to obtain a polypropylene suitable for use in the present invention by properly adjusting the amount of the electron-donating compound in the catalyst system, the amount of monomer(s) and the concentration of hydrogen in the polymerization system. In particular, the amount of the electron-donating compound in the catalyst system and the amount of monomer(s) influence the Tm and the CXS of the product, and the concentration of hydrogen in the polymerization system influences the MFR of the product.

To the polypropylene, additives may be blended.

Examples of such additives include antioxidants, UV absorbers, antistatic agents, lubricants, anti-clouding agents and anti-blocking agents.

The biaxially oriented film of the present invention may contain, in addition to the polypropylene resin, a resin other than the polypropylene resin.

Examples of the resin additionally used include polyolefin resins other than polypropylene.

The biaxially oriented film of the present invention is a biaxially oriented polypropylene film which satisfies the following formula (I):
Y≦−850×S+7000 (I)
wherein S represents the thermal shrinkage of the film in the longitudinal direction (MD) at 130° C. and Y represents the Young's modulus of the film in the transverse direction (TD). When the formula (I) is not satisfied, the rigidity of the film in its TD may be high enough, but the dimension stability at high temperatures may be poor or the film may be poor in balance between its properties.

From the viewpoint of processing stability at the time of heating, the thermal shrinkage of the film in the MD at 120° C. is not more than 3%, and preferably not more than 2.5%.

In the present invention, the thermal shrinkage at a predetermined temperature means a ratio of the length of the shrinkage of a film caused by heating of the film at the predetermined temperature to the original length of the film before the heating. As the length of the film before heating, the length of the film at 23° C. is used.

The biaxially oriented film of the present invention may be produced by subjecting a thermoplastic material comprising the above-described specific polypropylene to a biaxially stretching process generally used in the production of biaxially oriented films. The biaxial stretching of an extrudate of the thermoplastic material may be carried out by various types of biaxially stretching techniques, for example, sequential biaxial stretching, simultaneous biaxial stretching and tubular biaxial stretching.

According to the present invention, biaxially oriented polypropylene films which are excellent in rigidity and also in dimension stability and anti-blocking property at high temperatures can be obtained.

The biaxially polypropylene films of the present invention can be used as films for lamination, barrier films, films for aqueous ink printing, films for release sheet, films for food wrapping or packaging, and the like.

### EXAMPLES

The present invention will be described in more detail by reference to Examples and Comparative Examples. The methods for preparing the samples used in the Examples and Comparative Examples and the methods for measuring physical properties are shown below.

(1) 1-Butene Content (Unit: % by Weight)

For a propylene-1-butene copolymer, the content of 1-butene in the copolymer was determined based on an IR spectrum measured using the method described in Macromolecule Handbook (1995, published by Kinokuniya), page 619.

(2) Ethylene Content (Unit: % by Weight)

For a propylene-ethylene copolymer, the content of ethylene in the copolymer was determined based on an IR spectrum measured using the method described in Macromolecule Handbook (1995, published by Kinokuniya), page 616.

(3) 20° C. Xylene-Soluble Fraction Content

One gram of resin sample was dissolved completely in 100 ml of boiling xylene and then cooled to 20° C. After being left for four hours at that temperature, the mixture was separated by filtration in to a solid and a solution. The xylene was removed by evaporation and the residue was dried under reduced pressure at 70° C. The percentage of the weight of the resultant material to the weight of the original sample (1 g) was used as the 20° C. xylene-soluble fraction content (CXS).

(4) Melt Flow Rate (MFR; Unit: g/10 min.)

The melt flow rate of resin was determined according to JIS K 7210 at a temperature 230° C. under a load 21.18 N.

(5) Melting Point (Tm, Unit: ° C.)

A polypropylene was hot press molded into a sheet 0.5 mm in thickness. In the hot press molding, the polypropylene was preheated in a hot press molding machine at 230° C. for five minutes. Then, the pressure applied to the polypropylene was increased up to 50 kgf/cm² in three minutes and the pressure was maintained for two minutes. Subsequently, the pressed sheet was cooled to 30° C. for five minutes under a pressure 30 kgf·cm². Using a differential scanning calorimeter (Model DSC-7, manufactured by PerkinElmer Inc.), a 10 mg portion taken from the pressed sheet was subjected to a thermal hysteresis including the operations [1] through [5] shown below under a nitrogen atmosphere. Then, the sheet was heated from 50° C. to 180° C. at a rate 5° C./min. and a fusion curve (DSC curve) was produced during the heating. In the resulting fusion curve, a temperature (° C.) at which a highest endothermic peak appeared was determined. The temperature was used as the melting point (Tm) of the polypropylene.
[1] To hold a sample at 220° C. for five minutes.
[2] To cool the sample from 220° C. to 150° C. at a rate of 300° C./min.
[3] To hold the sample at 150° C. for one minute.
[4] To cool the sample from 150° C. to 50° C. at a rate 5° C./min.
[5] To hold the sample at 50° C. for one minute.
   (6) Heat Shrinkage (Unit: %)

A specimen with the size of A4 was taken from a film so that its major axis matched the MD of the film. Marked lines 20 cm long were drawn on the specimen so that one was along the major axis of the specimen and the other was along the minor axis. The marked specimen was hung for five minutes in an oven which was maintained at a predetermined temperature. Then the specimen was then removed from the oven and cooled at 23° C. for 30 minutes. Then, the length (cm) of each marked line was measured. The thermal shrinkage in each direction was calculated according to the following formula:
Thermal shrinkage (%)={(20−Length of marked line after heating)/20}×100
(7) Young's Modulus (Unit: MPa)

A specimen 120 mm in length and 20 mm in width was taken from a film so that its major axis matched the MD of the film. On the other hand, another specimen 120 mm in length and 20 mm in width was taken from the same film so that its major axis matched the TD of the film. For each specimen, an S-S curve was produced using a tensile tester under conditions including a chuck spun of 60 mm and a tensile rate of 5 mm/min. Thus, an initial modulus, which is a Young's modulus, was determined.

(8) Blocking (Unit: kg/12 cm²)

Two specimens taken from the same film were superposed together and a load of 500 g/12 cm² was applied to the specimens at 60° C. for 3 hours. Then, the specimens, which had been stuck to each other, were peeled off from each other under shearing and the load (kg) needed for the peeling was measured. Based on the measurement, the degree of blocking was indicated in the unit of kg/12 cm².

### Example 1

[Preparation of Solid Catalyst]

Following replacement of the atmosphere in a 200-L SUS reactor equipped with a stirrer, 80 L of hexane, 6.55 mol of tetrabutoxytitanium, 2.8 mol of diisobutyl phthalate and 98.9 mol of tetraethoxysilane were fed to form a homogeneous solution. Then, 51 L of 2.1-mol/L butylmagnesium chloride solution in diisobutyl ether was dropped slowly over 5 hours while holding the temperature in the reactor at 5° C. After the dropping, the mixture was stirred at room temperature for additional one hour. Subsequently, the mixture was subjected to solid-liquid separation at room temperature and washed with three 70-L portions of toluene.

Then, the toluene was drained so that the slurry concentration became 0.6 kg/L. Thereafter, a mixture of 8.9 mol of di-n-butyl ether and 274 mol of titanium tetrachloride was added and 20.8 mol of phthalic chloride was further added. A reaction was carried out at 110° C. for three hours. After the completion of the reaction, the mixture was washed with two 70-L portions of toluene at 95° C.

After the slurry concentration was adjusted to 0.6 kg/L, 3.13 mol of diisobutyl phthalate, 8.9 mol of di-n-butyl ether and 137 mol of titanium tetrachloride were added and then a reaction was carried out at 105° C. for one hour. After the completion of the reaction, solid-liquid separation was performed at that temperature and the resulting solid was washed with two 90-L portions of toluene at 95° C.

Subsequently, after the slurry concentration was adjusted to 0.6 kg/L, 8.9 mol of di-n-butyl ether and 137 mol of titanium tetrachloride were added and the resulting mixture was reacted at 95° C. for one hour. After the completion of the reaction, solid-liquid separation was performed at that temperature and the resulting solid was washed with three 90-L portions of toluene at the same temperature (95° C.).

Subsequently, after the slurry concentration was adjusted to 0.6 kg/L, 8.9 mol of di-n-butyl ether and 137 mol of titanium tetrachloride were added and the resulting mixture was reacted at 95° C. for one hour.

After the completion of the reaction, solid-liquid separation was performed at that temperature (95° C.) and the resulting solid was washed with three 90-L portions of toluene at the same temperature (95° C.). After additional washing with three 90-L portions of hexane, the residue was dried under reduced pressure, yielding 11.0 kg of solid catalyst component.

The solid catalyst component contained 1.89% by weight of titanium atom, 20% by weight of magnesium atom, 8.6% by weight of phthalate, 0.05% by weight of ethoxy group and 0.21% by weight of butoxy group. It was free of fine powder and had good particle properties.

[Preliminary Activation of Solid Catalyst]

1.5 L of n-hexane, which was fully dehydrated and degassed, 37.5 mmol of triethylaluminum, 3.75 mmol of t-butyl-n-propyldimethoxysilane and 15 g of the above solid catalyst component were added to a 3-L stainless autoclave equipped with a stirrer. Then, 15 g of propylene was continuously fed in 30 minutes while the internal temperature was kept at 5 to 15° C. Thus, preliminary activation of the catalyst was conducted. The resulting solid catalyst slurry was transferred to a 200-L stainless autoclave equipped with a stirrer and was diluted with 140 L of liquid butane. The mixture was stored at a temperature not higher than 5° C.

[Preparation of Polypropylene]

In a reactor equipped with a stirrer, polypropylene was obtained by continuous vapor phase polymerization at a polymerization temperature 80° C. and a polymerization pressure 1.8 MPa during which the preliminarily activated solid catalyst component, triethylaluminum and t-butyl-n-propyldimethoxysilane were fed under conditions where the concentrations of propylene, 1-butene and hydrogen in the vapor phase were kept constant. The butene content of the resulting polymer was 3.0% by weight. The polymerization conditions are summarized in Table 1.

[Pelletization of Composition]

To 100 parts by weight of a powder of the resulting polypropylene, 0.1 part by weight of calcium stearate, 0.15 part by weight of Irganox 1010 (manufactured by Ciba Specialty Chemicals Corp.) and 0.1 part by weight of Irgaphos 168 (manufactured by Ciba Specialty Chemicals Corp.) were blended and then the resulting mixture was melt-kneaded to yield pellets. The physical properties of the pellets are summarized in Table 2.

[Preparation of Biaxially Oriented Film]

Using a T-die extruder containing a 65-mmφ screw, the pellets were melt-extruded at a resin temperature of 260° C. and the extrudate was cooled rapidly on a chill roll at 30° C. to yield a sheet xx μm in thickness. Using a longitudinal stretching machine, the sheet was stretched five times in the MD using the difference in peripheral speed between the rolls of the machine while being heated at a longitudinal stretching roll temperature of 145° C. Subsequently, the sheet was stretched eight times in the TD at a stretching temperature of 157° C. in an oven using a tenter machine (manufactured by Mitsubishi Heavy Industries, Ltd.), followed by heat treatment at 165° C. to yield a biaxially oriented film 25 μm in thickness. The physical properties of the film are summarized in Table 3.

### Example 2

A propylene-1-butene copolymer, pellets and a biaxially oriented film were produced in the same manners as those used in Example 1 except changing the gas composition in the vapor phase and the concentration of the catalyst used during polymerization as shown in Table 1. The basic physical properties of the pellets and the physical properties of the biaxially oriented film are summarized in Table 2 and Table 3, respectively.

### Example 3

A propylene-1-butene copolymer, pellets and a biaxially oriented film were produced in the same manners as those used in Example 1 except changing the gas composition in the vapor phase and the concentration of the catalyst used during polymerization as shown in Table 1. The basic physical properties of the pellets and the physical properties of the biaxially oriented film are summarized in Table 2 and Table 3, respectively.

### Comparative Example 1

Using propylene-ethylene copolymer pellets, Sumitomo Noblen FS2011DG2 (manufactured by Sumitomo Chemical Co., Ltd.), pellets and a biaxially oriented film were produced in similar to those used in Example 1. The basic physical properties of the pellets and the physical properties of the biaxially oriented film are summarized in Table 2 and Table 3, respectively.

### Comparative Example 2

Using propylene homopolymer pellets, Sumitomo Noblen FS3012 (manufactured by Sumitomo Chemical Co., Ltd.), pellets and a biaxially oriented film were produced in similar to those used in Example 1. The basic physical properties of the pellets and the physical properties of the biaxially oriented film are summarized in Table 2 and Table 3, respectively.

### Comparative Example 3

A propylene-ethylene copolymer, pellets and a biaxially oriented film were produced in the same manners as those used in Example 1 except changing the gas composition in the vapor phase and the concentration of the catalyst used during polymerization as shown in Table 1. The basic physical properties of the pellets and the physical properties of the biaxially oriented film are summarized in Table 2 and Table 3, respectively.

TABLE 1

| | | | | | Catalyst | | Catalyst | Average |
|---|---|---|---|---|---|---|---|---|
| | | | | | Concentration | | Activity | Residence |
| | Gas Composition (vol %) | | | | (mmol/hr) | | PP/Cat | Time |
| | [C′3] | [H2] | [C′4] | [C′2] | [TEA] | [tBnPDMS] | (g/g) | (hr) |
| Example 1 | 87.33 | 1.2 | 1.8 | 0 | 42.7 | 6.82 | 23650 | 2.9 |
| Example 2 | 86.34 | 1.9 | 1.5 | 0 | 42.5 | 6.25 | 25450 | 2.7 |
| Example 3 | 86.23 | 1.9 | 1.4 | 0 | 41.3 | 6.13 | 25380 | 2.9 |
| Comparative | 90.67 | 0.9 | 0 | 0.1 | 40.2 | 3.45 | 20348 | 2.4 |
| Example 3 | | | | | | | | |

(Note 1)
[C′3] represents the concentration of propylene, which is indicated by taking the combined amount of the gas present in the reactor as 100 vol %.
(Note 2)
[H2], [C′2] and [C′4] represent the concentrations of hydrogen, ethylene and 1-butene, respectively, which reindicated by taking the combined amount of the hydrogen, the ethylene and the 1-butene as 100 vol %.
(Note 3)
TEA and tBnPDMS denote triethylaluminum and t-butyl-n-propyldimethoxysilane, respectively.

TABLE 2

| | | | Physical Properties of | | |
|---|---|---|---|---|---|
| | Comonomer Content | | Pellets | | |
| | (wt %) | | MFR | CXS | |
| | C′2 | C′4 | (g/10 min.) | (%) | Tm (° C.) |
| Example 1 | 0 | 3.0 | 2.4 | 0.7 | 156.5 |
| Example 2 | 0 | 2.2 | 2.5 | 0.7 | 158.8 |
| Example 3 | 0 | 1.7 | 2.7 | 0.7 | 160.3 |
| Comparative | 0.6 | 0 | 1.9 | 3.3 | 159.9 |
| Example 1 | | | | | |
| Comparative | 0 | 0 | 3.8 | 3.5 | 161.6 |
| Example 2 | | | | | |
| Comparative | 0.2 | 0 | 2.6 | 0.9 | 162.5 |
| Example 3 | | | | | |

TABLE 3

| | | | | | | | Young's | | | |
|---|---|---|---|---|---|---|---|---|---|---|
| | Heat Shrinkage (%) | | | | | | Modulus | | | |
| | (120° C.) | | (130° C.) | | (140° C.) | | (MPa) | | | Formula |
| | MD | TD | MD | TD | MD | TD | MD | TD | Blocking | (1) |
| Example 1 | 2.2 | 0.7 | 3.2 | 2.3 | 4.9 | 5.8 | 2220 | 4010 | 0.22 | ∘ |
| Example 2 | 1.9 | 0.8 | 2.8 | 2.3 | 4.1 | 5.8 | 2250 | 4340 | 0.30 | ∘ |
| Example 3 | 1.7 | 0.8 | 2.4 | 2.3 | 3.1 | 5.1 | 2290 | 4720 | 0.28 | ∘ |
| Comparative Example 1 | 3.3 | 1.3 | 4.7 | 3.5 | 6.7 | 7.5 | 2040 | 3940 | 0.40 | x |
| Comparative Example 2 | 2.7 | 1.1 | 3.6 | 3.1 | 5.2 | 6.7 | 1970 | 4430 | 0.88 | x |
| Comparative Example 3 | 2.7 | 0.9 | 3.2 | 2.1 | 4.2 | 4.4 | 2120 | 4340 | 0.10 | x |

(Note)
In “Formula (I)” column, symbol “∘” means that the formula (1) is satisfied, whereas symbol “x” means that the formula (1) is not satisfied.

The biaxially oriented films of Examples 1-3 are excellent in rigidity and in both dimension stability and anti-blocking property at high temperatures.

On the other hand, in Comparative Example 1, which does not meet the requirement about the 20° C. xylene-soluble fraction content (CXS) and does not satisfy the formula (I), the rigidity and the dimension stability at high temperatures were insufficient. In Comparative Example 2, the dimension stability at high temperatures was insufficient though the rigidity in the transverse direction (TD) was high enough. In Comparative Example 3, the film is of poor balance, in particular, the rigidity in the MD is insufficient through the rigidity in the TD is high enough.

1. A biaxially oriented film made of a thermoplastic material containing a polypropylene satisfying the following requirements (1), (2) and (3):
(1) the polypropylene has a melting point from 150° C. to 165° C.,
(2) the 20° C. xylene-soluble fraction content in the polypropylene is from 0.1% by weight to 2% by weight,
(3) the polypropylene has a melt flow rate from 0.1 g/10 min. to 10 g/10 min.,
wherein the film satisfies the following formula (I):
Y≦−850×S+7000 (I)
wherein S represents the thermal shrinkage of the film in the longitudinal direction (MD) at 130° C. and Y represents the Young's modulus of the film in the transverse direction (TD), and wherein the thermal shrinkage of the film in the MD at 120° C. is 3% or less.

2. The biaxially oriented film according to claim 1, wherein the polypropylene is a propylene-1-butene copolymer.
